(19) United States
(12) Patent Application Publication
(10) Pub. No.: US 2026/0293890 A1
(43) Pub. Date: Oct. 1, 2026

(54) CUTIN COMPOSITIONS FOR TREATMENT OF PLANT DISEASE

(71) Applicant: UNIVERSIDADE NOVA DE LISBOA, Oeiras (PT)

(72) Inventors: Cristina Maria DA COSTA SILVA PEREIRA, Oeiras (PT); Carlos Jorge DA SILVA MOREIRA, Oeiras (PT); Rita JOSÉ QUINTAL MARTINS ESCÓRCIO, Oeiras (PT); Artur Joao GONCALVES BENTO, Oeiras (PT)

(73) Assignee: UNIVERSIDADE NOVA DE LISBOA, Oeiras (PT)

(21) Appl. No.: 19/481,182

(22) PCT Filed: May 6, 2024
(86) PCT No.: PCT/EP2024/062419

§ 371 Date: Nov. 4, 2025

(30) Foreign Application Priority Data
May 4, 2023 (PT) 20232004894431

(51) Int. Cl. A01N 37/14; A01P 1/00; A01P 3/00

(52) U.S. Cl. CPC A01N 37/14; A01P 1/00; A01P 3/00

(57) ABSTRACT

The invention relates to a composition comprising isolated cutin polymer and/or cutin oligomers for use in prevention or treatment of plant disease, and to a method for prevention or treatment of plant disease, comprising contacting the aerial parts of a plant, particularly leaves and fruit of a plant, with a composition comprising a cutin product consisting of isolated cutin polymer and/or an oligomeric hydrolyzation product of a cutin polymer.

This application claims benefit of Portuguese provisional patent application 20232004894431, filed 4 May 2023, incorporated herein by reference.

### FIELD

The present invention relates to compositions comprising cutin oligomeric compounds, for use in prophylaxis and treatment of plant infections.

### BACKGROUND

Plants occupied land environments approximately 450 million years ago. This transition from water to land habitats exposed plants to numerous challenges imposed by an extremely desiccating environment. To control water loss, protect against UV radiation and against pathogens, and reinforce the epidermal cell layer, plants developed a hydrophobic barrier—the cuticle. The cuticle is composed by a polymeric matrix of cutin, to which organic solvent soluble lipids (waxes) associate. In addition, cutin interaction with the polysaccharides that build up the epidermal cell walls has been proposed, but the nature of such anchoring remains uncertain.

During infection of the aerial organs of plants, fungal spores release cutin-degrading esterases, termed cutinases, that are able to disrupt the polymeric matrix and release cutin-derived molecules. Perception of these molecules by the fungus increases the production of cutinases, consequently the cuticle barrier is breached, allowing the fungus to invade the plant organ.

To fend off pathogen invasion, plants have developed a highly specialized mechanism to sense biotic threats by using cell surface pattern recognition receptors (PRRs). These receptors perceive pathogen-associated molecular patterns (PAMPs) and damage-associated molecular patterns (DAMPs), derived from the invading pathogens or from the breakdown of plant tissues, respectively. Cutin aliphatic monomers (i.e. the major basic elements composing the cutin polymer) have been proposed as DAMPs due to their ability to induce some elements of a canonical immune response, namely the production of reactive oxygen species (ROS) in cucumber, rice and Arabidopsis thaliana (hereafter Arabidopsis), and the upregulation of defence-related genes in rice and Arabidopsis. Exogenous application of monomers obtained from plants having augmented cuticular permeability (SISHN3-OE), increased the resistance of Micro-Tom tomato plants against the fungal pathogen Botrytis cinerea, and activated defence responsive genes; however, the nature of the elicitor(s) remains unresolved. Cutin aliphatic monomers were also reported to induce the production of antimicrobial compounds. Although cutin monomers have been proposed as DAMPs, their capabilities to elicit other important hallmark early immune responses, for example intracellular calcium influx and activation of mitogen-activated protein kinases (MAPKs), have never been observed. Also, it is unclear if the tested cutin aliphatic monomers are the most potent class of cutin-derived DAMPs. Esterase-based degradation of cutin progresses through ester-cleavage, likely releasing cutin oligomers and not only monomers. This raises the hypothesis that cutin oligomers act as DAMPs, similar to that proposed for cutin monomers.

Based on the above-mentioned state of the art, the objective of the present invention is to provide means and methods to means and methods for improved protection of plants against crop disease. This objective is attained by the subject-matter of the independent claims of the present specification, with further advantageous embodiments described in the dependent claims, examples, figures and general description of this specification.

### SUMMARY OF THE INVENTION

A first aspect of the invention relates to a composition comprising isolated cutin polymer and/or cutin oligomers for use in prevention or treatment of plant disease.

An alternative of this first aspect of the invention may be formulated as a method for prevention or treatment of plant disease. Such method comprises contacting the aerial, i.e. the above ground parts of a plant, particularly leaves and fruit of the plant, with a composition comprising a cutin product consisting of
a. isolated cutin polymer and/or
b. an oligomeric hydrolyzation product of a cutin polymer (referred to herein also as “oligomeric hydrolyzation product”).

### Terms and Definitions

### General

For purposes of interpreting this specification, the following definitions will apply and whenever appropriate, terms used in the singular will also include the plural and vice versa. In the event that any definition set forth below conflicts with any document incorporated herein by reference, the definition set forth shall control.

The terms “comprising”, “having”, “containing”, and “including”, and other similar forms, and grammatical equivalents thereof, as used herein, are intended to be equivalent in meaning and to be open-ended in that an item or items following any one of these words is not meant to be an exhaustive listing of such item or items, or meant to be limited to only the listed item or items. For example, an article “comprising” components A, B, and C can consist of (i.e., contain only) components A, B, and C, or can contain not only components A, B, and C but also one or more other components. As such, it is intended and understood that “comprises” and similar forms thereof, and grammatical equivalents thereof, include disclosure of embodiments of “consisting essentially of” or “consisting of.”

Where a range of values is provided, it is understood that each intervening value, to the tenth of the unit of the lower limit, unless the context clearly dictates otherwise, between the upper and lower limit of that range and any other stated or intervening value in that stated range, is encompassed within the disclosure, subject to any specifically excluded limit in the stated range. Where the stated range includes one or both of the limits, ranges excluding either or both of those included limits are also included in the disclosure.

Reference to “about” a value or parameter herein includes (and describes) variations that are directed to that value or parameter per se. For example, description referring to “about X” includes description of “X.”

As used herein, including in the appended claims, the singular forms “a”, “or” and “the” include plural referents unless the context clearly dictates otherwise.

“And/or” where used herein is to be taken as specific recitation of each of the two specified features or components with or without the other. Thus, the term “and/or” as used in a phrase such as “A and/or B” herein is intended to include “A and B,” “A or B,” “A” (alone), and “B” (alone). Likewise, the term “and/or” as used in a phrase such as “A, B, and/or C” is intended to encompass each of the following aspects: A, B, and C; A, B, or C; A or C; A or B; B or C; A and C; A and B; B and C; A (alone); B (alone); and C (alone).

Unless defined otherwise, all technical and scientific terms used herein have the same meaning as commonly understood by one of ordinary skill in the art (e.g., in cell culture, molecular genetics, nucleic acid chemistry, hybridization techniques and biochemistry, organic synthesis). Standard techniques are used for molecular, genetic, and biochemical methods (see generally, Sambrook et al., Molecular Cloning: A Laboratory Manual, 4th ed. (2012) Cold Spring Harbor Laboratory Press, Cold Spring Harbor, N.Y. and Ausubel et al., Short Protocols in Molecular Biology (2002) 5th Ed, John Wiley & Sons, Inc.) and chemical methods.

The term cutin in the context of the present specification relates to a waxy polymer that, together with structurally distinct cutan, is one of the main components of the plant cuticle, which covers all aerial surfaces of plants. Cutin is an insoluble substance with waterproof quality. Cutin may also comprise cuticular waxes, which assist in cuticle structure. Cutin consists of omega hydroxy acids and their derivatives, which are interlinked via ester bonds, forming a polyester polymer of indeterminate size. Two major monomer families of cutin exist, the C16 and C18 families. The C16 family consists mainly of 16-hydroxy palmitic acid and 9,16- or 10,16-dihydroxypalmitic acid. The C18 family consists mainly of 18-hydroxy oleic acid, 9,10-epoxy-18-hydroxy stearic acid, and 9,10,18-trihydroxystearate. Rich C18 cutins are however not common, found for example in the leaves of Arabidopsis.

The term cutin oligomers in the context of the present specification relates to hydrolyzation products of cutin that contain from two to ten, particularly from two to seven, acyl monomers, particularly dihydroxy acid monomers. In very particular embodiments, the term cutin oligomers relates to hydrolyzation products of cutin that contain from two to five dihydroxy acid monomers.

The term pomace in the context of the present specification relates to the solid remains of tomatoes, grapes, olives, or other fruit after pressing for juice or oil. It contains the skins, pulp, seeds, and stems of the fruit.

### DETAILED DESCRIPTION OF THE INVENTION

To investigate the hypothesis that cutin oligomers (COMs) can activate PTI responses, cutin polyester was first isolated from tomato peel (Moreira, C. J. S. et al. Plant Physiol 184, (2020)), and subsequently broken down through a mild chemical hydrolysis to generate COMs. As such, the ensuing COMs constitute an adequate model of cutins comprising 10,16-dihydroxyhexadecanoic acid (dihydroxy-C16 acid) units. The ability of the produced COMs to activate calcium influx, MAPK activation and transcriptional reprograming in Arabidopsis was investigated. The results clearly indicate that COMs act as elicitors of rapid immune responses. Spectroscopy and spectrometry analyses suggested that the elicitors consist of dimers and/or trimers consisting mostly of esterified 10,16-dihydroxyhexadecanoic acid units, one of which possibly methylated. The hypothesis that cutin disruption releases oligomers able to act as elicitors of plant immunity, hence potentially constituting a new class of DAMPs, is discussed.

A first aspect of the invention relates to a composition comprising isolated cutin polymer and/or cutin oligomers for use in prevention or treatment of plant disease.

An alternative of this first aspect of the invention may be formulated as a method for prevention or treatment of plant disease. Such method comprises contacting the aerial, i.e. the above ground parts of a plant, particularly leaves and fruit of the plant, with a composition comprising a cutin product consisting of
c. isolated cutin polymer and/or
d. an oligomeric hydrolyzation product of a cutin polymer (referred to herein also as “oligomeric hydrolyzation product”).

Particularly preferred is the use of oligomeric hydrolyzation product of cutin.

In particular embodiments of the composition for use according to the invention, or alternatively of the method according to the invention, the composition is an aqueous composition comprising 0.001% to 0.5%, or 0.001 to 0.4% (w/w) of cutin product. In more particular embodiments, the composition comprises 0.01% to 0.2% (w/w) of cutin product, particularly of the oligomeric hydrolyzation product. In other embodiments, the composition comprises 0.01 to 0.4% of oligomeric hydrolyzation product.

The inventors tested compositions having 0.001% (w/w) to 0.4% (w/w) oligomeric hydrolyzation product to favourable effect.

In certain embodiments, the cutin product is isolated from tomato pomace.

In other embodiments, the cutin product is isolated from grape (Vitis vinifera) pomace. In still other embodiments, the cutin product is isolated from pepper (capsicum) pomace, which is distinguished by cutin polymers comprising fatty acid chains containing epoxide groups.

The inventors found that in addition to tomato pomace, which formed the starting point of the current invention, pomaces obtained from grapes and peppers all imparted the advantageous effect of protecting crops against infection. Without wanting to be bound by theory, the inventors assume that the cited fruit cutin species serve as a model, but cutin recovered from any fruits/leaves will show the effect demonstrated for tomato, grape and pepper cutin.

In particular embodiments of the composition for use according to the invention, or alternatively of the method according to the invention, the cutin product is a cutin oligomeric composition obtained by hydrolysis of cutin polymer by sodium methanoate.

Other standard methods of mild (i.e., incomplete) hydrolysis of plant polyester that may be employed to obtain the oligomeric hydrolyzation product of cutin include microwave application in solvent (water, methanol or mixes thereof).

In particular embodiments, the oligomeric hydrolyzation product of cutin comprises dimers and/or trimers of 10,16-dihydroxyhexadecanoic acid.

In more particular embodiments, the dimers and/or trimers of 10,16-dihydroxyhexadecanoic acid are present at least partially as methyl ester.

In other more particular embodiments, the dimers and/or trimers of 10,16-dihydroxyhexadecanoic acid comprise linear dimers or trimers joined through esterification of the ω-hydroxy group.

A formula of a linear trimer of 10,16-dihydroxyhexadecanoic acid is given here, wherein R can be hydrogen or methyl:

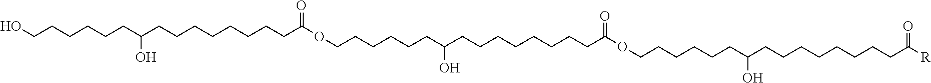

A formula of a branched dimer of 10,16-dihydroxyhexadecanoic acid is given here. Again, R can be hydrogen or methyl:

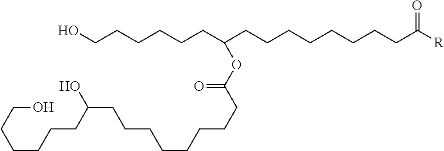

A formula of a branched trimer of 10,16-dihydroxyhexadecanoic acid is given below. Again, R can be hydrogen or methyl:

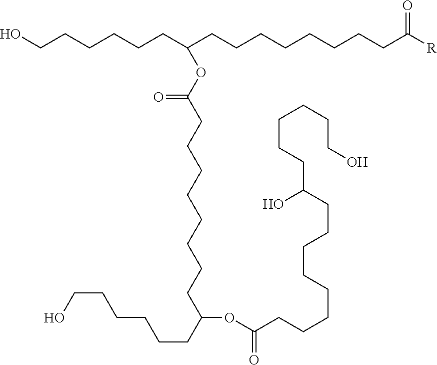

Another formula of a branched trimer of 10,16-dihydroxyhexadecanoic acid is given below. Again, R can be hydrogen or methyl:

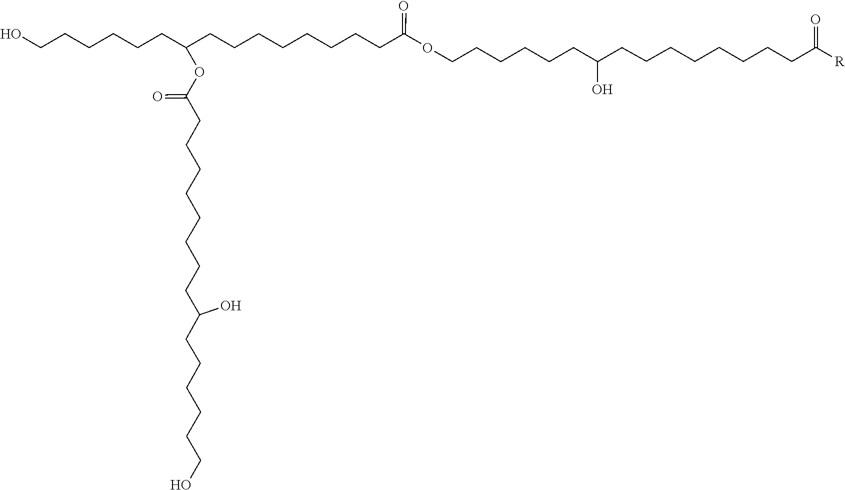

In certain embodiments, the composition comprises branched trimers. These species tested as most effective in plant protection in the inventors' hands.

In certain embodiments, the plant disease is a fungal infection. The inventors obtained good results in infection models of various fungal diseases, applying aqueous compositions of the cutin oligomers as described herein.

In certain embodiments, the plant disease is a bacterial infection.

In certain embodiments, the composition is applied prior to infection; in other words, the composition according to the invention is used in a prophylactic/preventive fashion.

Wherever alternatives for single separable features are laid out herein as “embodiments”, it is to be understood that such alternatives may be combined freely to form discrete embodiments of the invention disclosed herein.

The invention is further illustrated by the following examples and figures, from which further embodiments and advantages can be drawn. These examples are meant to illustrate the invention but not to limit its scope.

### DESCRIPTION OF THE FIGURES

FIG. 1 shows luminescence-based detection of apoplastic ROS in Arabidopsis Col-0 leaf discs upon treatment with 2 mg·mL-1 of cutin in MiliQ water for 30 min (A) and 45 min (B); C—1 mM of commercially available pure monomers (16-hydroxypalmitic acid (16-HPA), octanedioic acid (OCTDA) and ferulic acid (FERA)), and oligomers (glyceryl stearate (GS) and glyceryl tristearate (GTS)), in 10% ethanol in MiliQ water for 45 min; D—1 mg·mL-1 of cutin hydrolysate obtained after alkaline hydrolysis of cutin; E—2 mg·mL-1 of COM obtained through the methanolysis of cutin in 0.5% DMSO in MiliQ water; and F—co-treatment with 2 mg·mL-1 of COM and 100 nM Flg22 in 0.5% DMSO in MiliQ water. In all the assays the Mock consists of the solvent. The positive controls were Flg22 (100 nM) or Pep1 (100 nM).

FIG. 2 shows luminescence-based detection of calcium influx in Arabidopsis seedlings expressing the calcium reporter aequorin, upon treatment with: A—1 mg·mL1 of cutin in MiliQ water; B—2 mg·mL-1 of COM in 0.5% DMSO in MiliQ water. In all the assays the Mock consists of the solvent.

FIG. 3 shows GO term enrichment analysis of the genes that showed upregulation upon treatment with COM for 30 min.

FIG. 4 shows (A) luminescence-based detection of calcium influx in Arabidopsis thaliana seedlings, Col-0 and deletion mutants bak1-4 and cerk1, expressing the calcium reporter aequorin, upon treatment with 2 mg·mL⁻¹ of COM in 0.5% DMSO in MiliQ water. In all the assays the Mock consists of the solvent and the positive control is Flg22 (100 nM). To allow comparison between genotypes, all values are normalized by the aequorin discharge measurements. (B) COM-induced resistance against B. cinerea. Leaves of 4- to 5-week-old Col-0 plants were either painted with mock (ddH2O, 0.5% DMSO, 0.01% Silwet L77), 2 mg/ml COM or not painted 24 hours before drop-inoculation with B. cinerea strain BMM (5 μL; 5×105 spores/mL). 48 hours post inoculation, lesion areas were measured. Results show the mean±SE (n=3 leaves from 4-5 plants per experiment). Equal letters at the top of the panel indicate p>0.05, one-way ANOVA and post hoc Tukey test. Groups with alike letters are not statistically different. (C) luminescence-based detection of apoplastic ROS in Solanum lycopersicum leaf discs upon treatment with 1 mg·mL-1 of cutin in MiliQ water for 40 min. The Mock consists of the solvent and the positive control is Flg22 (100 nM). (D) luminescence-based detection of calcium influx in Arabidopsis thaliana and Nicotiana benthamiana leafdiscs expressing the calcium reporter aequorin, upon treatment with 2 mg·mL-1 of COM produced from red pepper peels, in 0.5% DMSO in MiliQ water. In this assay the Mock consists of the solvent and the positive control Flg22 (100 nM).

### DESCRIPTION OF THE TABLES

Table 1 shows GC-MS characterization of COM before (NH) and after alkaline hydrolysis (AH). List of the monomeric hydrolysable constituents of each sample after derivatization. Monomers that were not detected in a specific sample are labelled as n.d.

Table 2 shows list of putative oligomeric targets for LC-MS/MS analysis, their chemical formulas and the corresponding exact mass (neutral species only).

Table 3 shows NMR quantification of the relative abundances of esters types present in each COM calculated through the integration of signals in the corresponding 1H NMR spectra. Ester types detected on this analysis include, PAE (Primary aliphatic esters), SAE (Secondary aliphatic esters), ME (Methyl esters), EE (Ethyl esters) and ArE (Aromatic Esters). Esters that were not detected on a sample are labelled as n.d.

Table 4 shows the quantification of the total hydrolysable carbohydrates content present in cutin oligomeric mixtures (COMs).

### EXAMPLES

### Example 1: Cutin Polymer Activates a ROS Burst in Arabidopsis

We hypothesised that the degradation of the plant polyester cutin is coordinated with the release of polymeric/oligomeric variants capable to elicit hallmark early plant immune responses. We first tested a cutin polymeric variants ability to induce a ROS burst in Arabidopsis. Arabidopsis is a well-established model plant for studying PTI due to the diversity of established protocols and plant resources, including characterised mutants and reporter lines. ROS burst was measured through a well-established protocol that detects a luminescence signal produced in the presence of H2O2 due to peroxidase (here, horseradish peroxidase, HRP)-mediated conversion of luminol (Zhu, H. et al., React Oxyg Species (Apex) 1, 216, 2016).

To obtain the cutin polymer, an ionic liquid extractant was applied to isolate a highly pure cutin polymer showing minor ester cleavage (Moreira, C. J. S. et al, Plant Physiol 184, 2020). This method ensures a faster and simpler recovery of cutin compared to the conventional enzyme-based isolation (Moreira, C. J. S. et al, 2020, ibid). The cutin was purified from tomato pomace since its high availability as an agroindustry residue enables production of large amounts of polymeric structures. Moreover, previous studies showed that cutin purified with an ionic liquid from tomato pomace (consisting of peels, seeds and fibres) is virtually similar to that obtained from the tomato peel fraction alone.

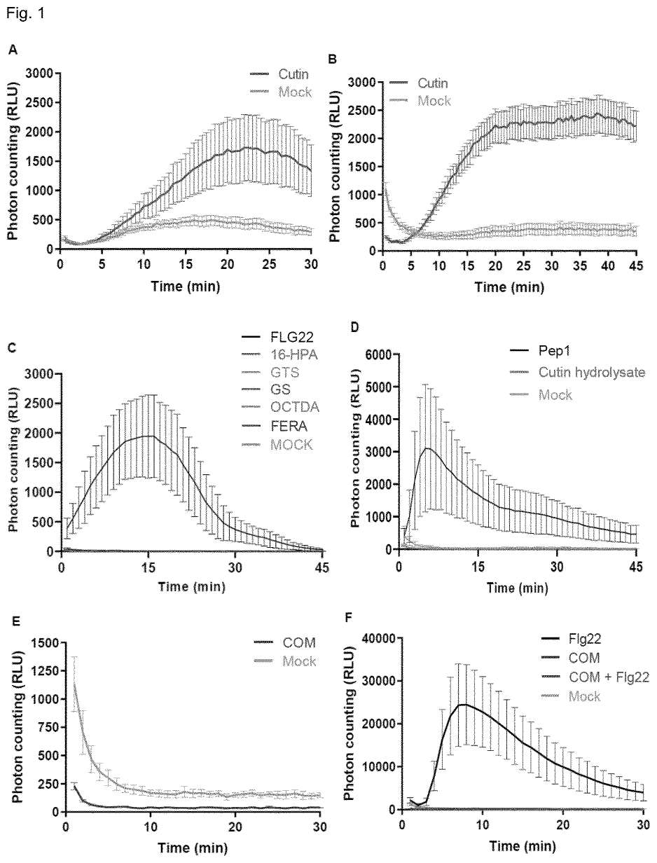

Exposure of seedlings of Arabidopsis to cutin (suspension in MiliQ water) resulted in a clear ROS burst (FIG. 1A-B). Flg22, a 22-aminoacid peptide derived from bacterial flagellin, is a well-established strong inducer of plant immunity (used here as positive control). The effect was reproducible, and the response was not depleted at 45 min post-treatment (FIG. 1B). On the contrary, pure compounds (commercially available), which are representative of tomato cutin constituents: long chain fatty acids, hydroxycinnamic acids or fatty acid monoglycerides having variable side chains, did not induce a ROS burst under the tested conditions (FIG. 1C). Cutin hydrolysates, which are obtained by an extensive hydrolysis of the cutin, consist almost exclusively of aliphatic monomers with a few aromatic monomers. These hydrolysates also did not elicit a ROS burst (FIG. 1D). Collectively, the results suggest that once the polymeric backbone of the plant polyester is deconstructed to its composing monomeric pieces, its capability to elicit a ROS burst is lost; hence some preservation of the polymeric backbone might be required for the eliciting of a ROS burst in tomato leaves.

To test if small chains of monomers linked together through ester linkages; i.e. oligomers (<7), could act as elicitors, we prepared cutin oligomers (COMs). To produce these, cutin was depolymerised through a mild chemical hydrolysis and the released molecules were collected (see Materials and Methods). The produced COMs were unable to trigger a ROS burst (FIG. 1E). However, no effect was detected when the seedings were co-treated with flg22 and COM, although flg22 alone clearly induced a ROS burst (FIG. 1F). This result suggests that constituents of the COM interfered with the reporter of luminescence. In fact, the COM contains phenolic compounds (Table 1) and phenol oxidation has been reported to inactivate HRP activity in a concentration dependent mode (i.e. ratio enzyme: inhibitor). Cutin hydrolysates (mixture of all hydrolysable cutin monomers) also comprise low levels of phenolic compounds. There are alternative methods for ROS measurement; for example, DAB staining has been used to detect the accumulation of intracellular ROS in response to treatment with cutin aliphatic monomers, specifically hydroxy palmitic acid (HPA). Thus, while we observed that cutin aliphatic monomers did not induce an apoplastic ROS burst using a luminol-based assay, we cannot disregard the possibility that accumulation of intracellular ROS might occur at extended post-treatment periods.

The results clearly show that treatment of Arabidopsis with the cutin polymer induced a ROS burst (FIG. 1A) but not any of the tested pure cutin constituents (FIG. 1C). Due to the aforementioned technical limitation, to further test COMs activity as potential elicitors of plant immunity, we converged towards the calcium response—another hallmark early immune response.

### Example 2: Cutin Polymer and Oligomers, but not Cutin Hydrolysates, Activate a Calcium Influx in Arabidopsis

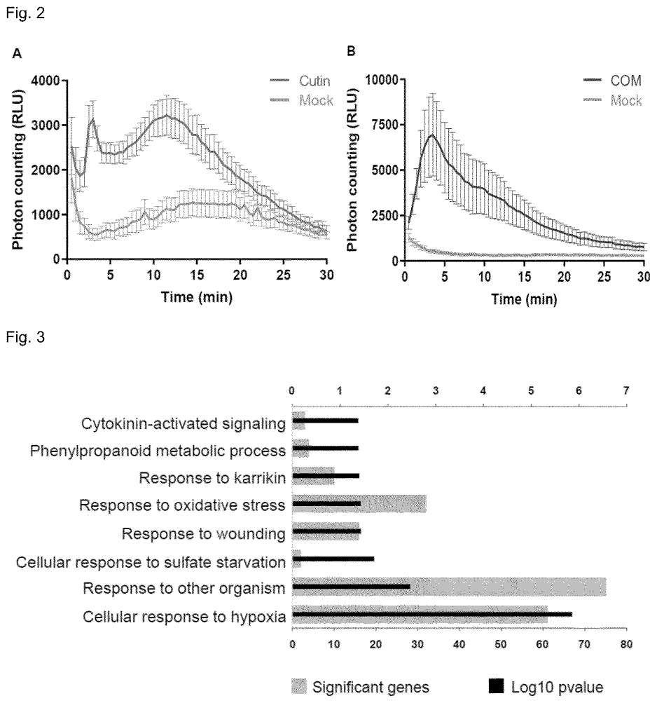

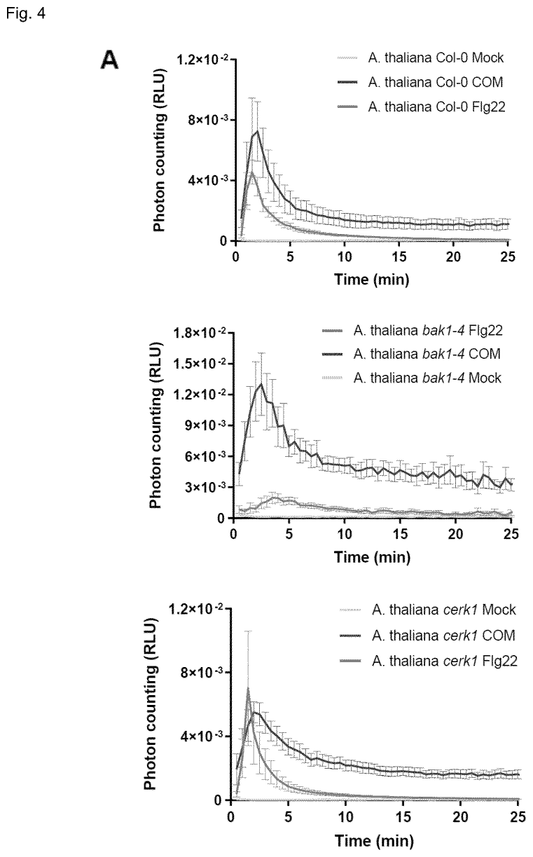

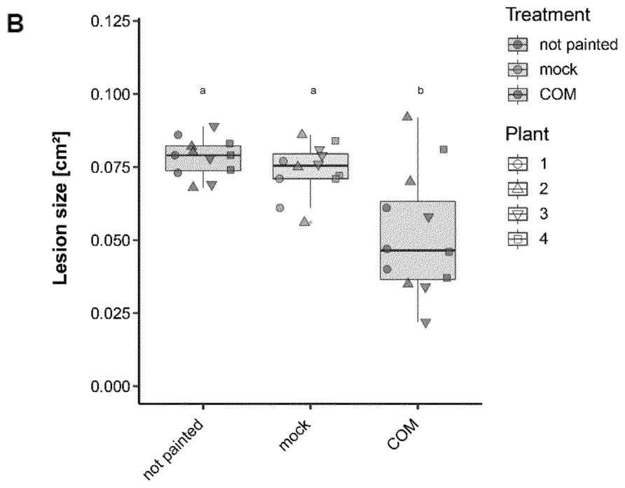

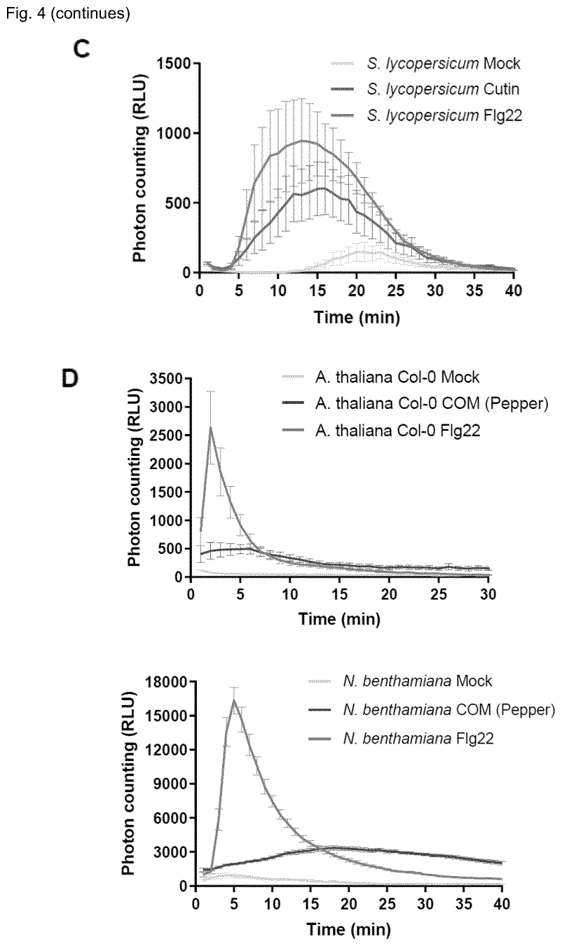

Both cutin and COMs showed a clear and reproducible induction of calcium influx in Arabidopsis plants expressing aequorin (FIG. 2A, 2B), a widely used calcium activated reporter of immune responses in plants. The response patterns were however different: cutin response was bimodal with maximum values at 3 min and 12 min (FIG. 2A), whereas COM response was monomodal with a maximum between 3 and 5 min (FIG. 2B). This result suggests that cutin may comprise several classes of chemical elicitors, one of which is prevalent in the COM fraction. Nicotiana benthamiana plants expressing aequorin when exposed to COMs also showed a calcium influx having a monomodal response-type. Since the eliciting molecules were similarly recognized by both tested plants, the elicitors are likely not species-specific.

Finally, no induction of a calcium influx was observed upon treatment of Arabidopsis seedlings with either HPA or cutin hydrolysates increasing concentrations. Collectively, these data validate the opening hypothesis that cutin small oligomers may act as elicitors of PTI. Mild deconstruction of the polymer potentiates its capability to induce a calcium influx in Arabidopsis, but its complete depolymerisation abolished this eliciting effect.

### Example 3: Cutin Oligomers Trigger MAPK Activation in Arabidopsis

PTI signalling events occurring downstream to elicitor perception involve the activation of MAP kinases. Accordingly, the capabilities of COM to activate MAP kinases in Arabidopsis Col-0 seedlings was evaluated. This immunoblot-based assay allows the detection of the phosphorylated (active) forms of MAPK 3, 4, 6 and 11 during PTI signaling (Willmann, R. et al., Methods in Molc Biol 1171, 2014). Short (10 min) exposure of Arabidopsis seedlings to COM activated hallmark MAPK activation; similar to that observed when the plants were exposed to flg22. Apart to the wild type plants, three mutants were also tested, single: cerk1-2, double: bak1-5 bkk1, and triple: bak1-5 bbk1 cerk1 (bbc). CHITIN ELICITOR RECEPTOR KINASE 1 (CERK1) is a common co-receptor for LysM-type PRRs while BRASSINOSTEROID INSENSITIVE 1-ASSOCIATED KINASE 1 (BAK1) and BAK1-LIKE KINASE 1 (BKK1) are common co-receptor for leucine-rich repeat-type PRRs. Thus, differences in the response pattern of the selected mutants may reveal potential families of PRR(s) that recognize the elicitor(s) within COM. The results showed that COM induced a clear activation of MAP kinases in all the mutants tested, similar to that observed in the wild-type plants. The observation that MAPK activation was similar in all mutants is suggestive of a perception mechanism independent on the families of PRRs known to associate with CERK1 and SERKs. Ultimately, these results suggest that COMs triggered a MAPK-mediated signalling cascade, opening the hypothesis that COM exposure also involves transcriptional reprogramming.

### Example 4: Cutin Oligomers Treatment Induced a Transcriptional Reprograming Consistent with Activation of PTI

We evaluated the transcriptional reprogramming in Arabidopsis seedlings upon a 30-min treatment with COM compared to mock control (RNA-seq). Previous studies covering distinct PTI elicitors showed significant responses at 30 min post-treatment. Principal components analysis (PCA) demonstrates that their transcriptomic profiles are clearly separating from each other. A total of 528 differentially expressed genes (DEGs) resulted from the COM treatment, of which 479 genes were upregulated, while only 49 were downregulated compared to the mock treatment. Enriched gene ontology (GO) categories were only obtained for the subset of upregulated genes due to the small number of downregulated genes. An enrichment for terms related to activation of plant immunity, particularly ‘response to wounding’ and ‘response to other organism’ was noticed (FIG. 3).

The observed transcriptional reprogramming induced by the COM treatment was compared to that induced (i.e. upregulated) by seven other well-characterised elicitors of plant immunity, recently reported by Bjornson et al., Nat Plants 7,579, 2021. The COM effect presents similarity with that of the other elicitors: 140 induced genes (~30%) responded to the COM and the other PTI elicitors. The transcriptional reprogramming induced by COM has however some uniqueness since 105 induced genes (~20%) were not induced by any of the other tested elicitors. In fact, such level of specificity in transcriptional reprogramming was previously only observed for flg22. The lower number of induced genes by COM treatment can be related to the single time point used, differently from the other elicitors of PTI where multiple timepoints were used (5 min up to 3 h). The genes induced only by COM (and not by the other elicitors) were matched with genes found to be upregulated under abiotic stress (seven types of stresses were considered, see Materials and Methods). We observed that among these, 32 genes were induced solely by COM and not by any of the abiotic stresses; further suggestive of a certain degree of uniqueness on the COM's effect.

The uniqueness of the COM treatment was further demonstrated through a correlation analysis of all transcriptomic datasets at the 30-min timepoint. At this timepoint, COM effect is not correlated with any of the other tested elicitors; for example, bacterial hydroxy-fatty acid (3-OH-FA) and fungal chitooctamer (CO8). It also showed no correlation with the effect of oligogalacturonides (OGs) originating from plant cell wall pectin degradation. Cutin anchoring to the cell wall is a long-standing debate, but the involvement of polysaccharide-based moieties has been suggested. Polysaccharides can be found at very low amounts in cutin isolated using the ionic liquid extractant, but it remains an unresolved question if the detected polysaccharide-moieties are covalently linked to cutin. No glycoside-type linkages were detected in the NMR spectral fingerprint of a highly concentrated COM sample: 40 mg to allow detection of low-intensity signals. Several molecules derived from cell wall polysaccharides can act as elicitors, for example OGs, cellobiose, arabinoxylan oligosaccharides and mixed-linked β-1,3/1,4-glucans41. However, the reported amounts for their eliciting effects usually range from μg·mL-1 to mg·mL-1. These levels are higher than those detected in the COM preparations that were observed to contain only picograms of hydrolysable sugars per mg of COM (Table 4). The acquired data thus indicate that the molecules within the COM preparation acting as elicitors have a lipidic nature.

### Example 5: Guiding Principles on the Chemistry of Cutin Oligomers Able to Elicit a Rapid Immune Response in Arabidopsis

COM preparations have been shown to consist of oligomers and monomers. During infection, pathogens can secrete enzymes able to hydrolyse ester-type linkages present in cutin; breaking the structural integrity of the cutin barrier to allow pathogen invasion of the infected plant tissue. To mimic such progressive attack of cutin, after obtaining a COM preparation, the non-hydrolysed cutin fraction was recovered. The recovered cutin was subjected to a second round of mild hydrolysis and subsequently processed to obtain a COM II fraction. In Arabidopsis plants, the signal-intensity of the COM II induced calcium influx was >2-fold higher than that observed after COM treatment. This observation suggests that COM II might be more enriched in active elicitors compared to COM.

The free monomers were detected (and quantified) by GC-MS analysis, that also differentiates the methylated derivatives formed during the cleavage of esters through the methanolysis reaction (Table 1). The presence of oligomers was directly inferred from the detection of both primary (PAE) and secondary aliphatic esters (SAE) through NMR analyses, specifically in the HSQC spectral fingerprints of either COM preparation. The integration of their corresponding 1H NMR signals, relative to an internal standard, was used to infer the relative amount of PAE (i.e. linear) and SAE (i.e. branched) (Table 3). Both types of esterification have been reported before in the spectral fingerprint of several cutin variants. The estimated relative abundances of methyl esters in COM range from 40 to 70% of the total esters, consistent with the GC-MS data (Table 1). To depolymerise all present oligomers, the COM was subjected to hydrolysis and reanalysed by GC-MS. Comparison of the resultant monomeric profiles of the COM and the resulting hydrolysate, exposed monomers increasing in abundance after hydrolysis (Table 1). The major aliphatic monomer of cutin, the 10,16-dihydroxyhexadecanoic acid (dihydroxy-C16 acid) is likely the major building block of the oligomers, distantly followed by 9,10-epoxy-18-hydroxyoctadecanoic acid, nonanedioic acid and hexadecanedioic acid.

A preliminary LC-MS/MS analysis was performed targeting the exact masses of dihydroxy-C16 acid dimers and trimers, carrying or not one methylation (Table 2). Pure HPA was used to setup the method (see Materials and Methods). The given outputs (Compound Discovery 3.2) were unsupervised since the software automatically computes for each given mass the most likely ions/adducts to be generated in negative/positive modes. In both COMs, dimers were putatively identified, namely two dihydroxy-C16 acid molecules esterified, methylated or not—DP2. A trimer of dihydroxy-C16 acid molecules, carrying or not one methylation, was putatively identified only in COM II—DP3. These molecules can be a linear chain yet one side-branch is possible. The NMR quantification data suggest that linear esters are in average two- to three-fold more abundant than branched esters (Table 3), accordingly the linear DP3 chain is more likely to exist.

A MALDI-TOF method was developed to screen for the putative presence of oligomers up to tetramers species. The MALDI-TOF analyses showed the presence of the most abundant free monomers in COM and COMII, some of which in the methylated form. The controls—cutin and COMs hydrolysates—also contain the same non-methylated monomers. In the COMs, dimers were identified, namely DP2, methylated or not, consistent with the LC-MS/MS. Other dimers detected consist of a dihydroxy-C16 acid esterified to coumaric acid without, or with one or two methylations—DP2c. The DP2c methylated molecules were only detected in the COM. The cutin hydrolysate (control) showed the presence of the non-methylated forms of DP2 and DP2c. NMR analyses of 40 mg of either COM, showed the presence of esterified aromatics only in COM. Finally, the methylated-DP3 and, its non-methylated form, were identified in COM II, regardless of undetected in COM possibly due to lower relative abundance. Collectively the data on the COMs (and cutin hydrolysates) suggest that amongst the identified oligomeric species, the best PTI elicitor candidates are linear dimers or trimers composed of dihydroxy-C16 acid units, one of which possibly methylated.

### Example 4: Discussion

The plant cell wall barrier is an important interface during plant-microbe interactions, where cutin is the outermost polymeric component. Plants are able to recognise damages caused by pathogens, and elicit immune responses for example upon recognition of cell wall-derived fragments acting as DAMPs. As such, the cell wall barrier orchestrates key responses of the plant interaction with the surrounding environment. This rationale has defined the major hypothesis of our study, namely that cutin oligomers act as DAMPs able to trigger plant immune responses. In Arabidopsis, cutin oligomers (COMs), obtained through methanolysis of tomato pomace cutin, elicited several hallmark immune responses, including calcium influx (FIG. 2) and MAPK activation, and a transcriptional response comprising features similar to those activated by well-characterized elicitors (FIG. 3). The perception mechanisms of the COMs, which was observed to be independent of BAK1/BKK1 and CERK1 co-receptors, remains yet unresolved.

Chemical analyses identified that the COMs contain trimers and dimers. The strongest elicitor candidates are the dihydroxy-C16 acid dimers (DP2) or trimers (DP3) carrying a methylation. DP2, methylated or not, were detected in both COMs. On the contrary, the DP3 and DP2c (dihydroxy-C16 acid esterified to coumaric acid), carrying or not methylation, were only detected in COM II and COM, respectively; yet, their abundances may be below the detection levels of the analytical methods used. The non-methylated DP2 and DP2c were present in cutin hydrolysates unable to elicit a calcium burst, though the threshold for PTI activation remains unknown. The methylation increases the oligomer's lipophilicity, possibly favouring its diffusion; a hypothesis that requires focussed analysis. Methyl-esters are for example present in seeds and vegetable oil. However, the isolated cutin polymer, which is deprived of methyl-esters, elicited a rapid ROS burst (FIG. 1A-B) and calcium influx (FIG. 2A). This observation questions the requirement of methylation for immune activation. Fungal lipases can generate methyl esters, for example from vegetable oil. In plants, the modification of cutin degradation products by microbial methyl-transferases, in the context of PTI, remains unknown. However, methylation to potentiate the eliciting effect of cutin oligomers, may inspire alternative biotechnological valorisation paths for fruit pomaces.

Both the cutin polymer (with minor degree of structural damage) and the generated oligomers acted as PTI elicitors. Previous work by others showed that some cutin monomers also activated some aspects of plant immunity. A step-by-step activation of specific elements of plant immunity by cutin having distinct degrees of structural damage, constitutes an appealing concept that deserves further investigation. The release of oligomeric elicitors during plant infection requires validation to attain a mechanistic understanding of cutin's multiple functions in plant-pathogen interactions. The identity of the precise COM elicitors remain putative, and efficient syntheses are needed to obtain pure compounds. However, COMs clearly constitute a new class of DAMPs. Hence, their production from agro-industrial residues constitutes a promising value chain and may support development of sustainable agricultural bio-based treatments to increase disease resistance.

### Example 6: Materials and Methods

### Plant Growth Conditions

Arabidopsis thaliana Col-0 seeds were germinated on soil and plants were grown for four-weeks on an Aralab Fitoclima climate chamber with 150 μmol s⁻¹ m⁻² light intensity, following a 10 h/14 h day/night cycle, under constant temperature of 20° C. and 60% humidity. Plants were watered automatically for 10 min three times per week. Arabidopsis thaliana Col-0 and the mutants bak1-5 bkk1, cerk1-2AEQ and bbc, all in the Col-0 background, seeds were germinated on plates with 0.5×Murashige and Skoog (MS) basal salt mixture supplemented with 1% (w/v) sucrose and 0.9% (w/v) phytoagar. After four days, seedlings were transferred to 24-well sterile culture plates containing 0.5×MS mixture supplemented with 1% (w/v) sucrose and grown in sterile conditions in a Aralab Fitoclima climate chamber with 120 μmol s⁻¹ m⁻² light intensity, following a 16 h/8 h day/night cycle, under temperatures of 20° C. during the day and 18° C. at night. The growth period was 8-days, 11-days or 14-days depending of the subsequent assays.

Nicotiana benthamiana plants seeds were germinated on soil and plants grown for four weeks on a greenhouse room with 150 μmol·s-1·m-2 light intensity, following 16 h/8 h day/night cycle, under constant temperature of 24° C. These plants were watered automatically daily for 20 min.

### Cutin Extraction

Cutin was extracted from tomato pomace as previously described (Moreira, C. J. S et al., 2020 ibid). The tomato pomace was obtained from Sumol+Compal, SA., and dried at 60° C. for one week until constant weight. Dry pomace was then milled using a Retsch ZM200 electric grinder (granulometry 0.5 mm; 10000 rpm) and stored at room temperature until further use. In brief, tomato pomace and cholinium hexanoate were mixed (1:10) and incubated for 2 h at 100° C. The reaction was stopped by the addition of 80 mL of DMSO per gram of tomato pomace. The polyester was recovered by filtration using a nylon membrane filter (0.45 μm). Purification was obtained by washing with an excess of deionized water to remove all traces of DMSO. Purified cutin were then freeze dried and stored at room temperature for further use. Suspensions of the purified cutin powder (insoluble) were prepared in MiliQ water for testing purposes, since they allow reproducible results.

### Cutin Hydrolysis

To obtain a cutin oligomeric mixture (COM), a sodium methoxide-catalyzed methanolysis was performed by mixing 0.5 g of cutin with 20 mL of a solution of sodium methoxide (0.1M) in anhydrous methanol, at 40° C. for 2 h without stirring. At the end of the reaction, the mixture was cooled to room temperature and centrifuged (4° C., 30 min, 4000 g) to recover the non-hydrolysed cutin fraction. The supernatant (hydrolysed fraction) was acidified to pH 3-3.5 by addition of HCl 37% and subsequently centrifuged (4° C., 30 min, 4000 g). The resulting precipitate was recovered, and the supernatant extracted three times by dichloromethane/water partition to release the hydrolysates; and sodium sulphate anhydrous was added to remove traces of water. The solution was concentrated under a constant nitrogen flux at 40° C. To obtain cutin or COM hydrolysates, a sodium hydroxide alkaline hydrolysis was performed by mixing a solution of 0.5 M NaOH in methanol/water (1:1, v/v) at 95° C. with the cutin/COM powder, for 4 h. At the end of the reaction, the mixture was cooled to room temperature, then acidified to pH 3/3.5 with 1 M HCl, and subsequently extracted by dichloromethane/water partition to release the hydrolysable constituents. The solution was concentrated under a constant nitrogen flux at 40° C. Stock solutions of the COMs were prepared in heated DMSO. Precise aliquots were dissolved in MiliQ water to reach a final concentration of 2 mg·mL-1 or 3 mg·mL-1 for testing purposes (see below).

### Immune Assays

Leaf discs (collected using a 4-mm biopsy punch) or seedlings were transferred to white 96-well plates (one leaf disc or seedling per well) and equilibrated overnight in sterile ultrapure water (ROS measurements) or coelenterazine solution (Calcium measurements). The following day, the equilibration solution was removed, and replaced with a solution containing 100 μg·mL⁻¹ up to 2 mg·mL⁻¹ of COM, cutin hydrolysate, hydroxy palmitic acid (HPA) or cutin (Calcium measurements), and mixed with 1 mM luminol, and 10 μg·mL⁻¹ HRP in the case of ROS measurements. Two mg·mL-1 of COM were tested since this concentration was sufficient to observe a reproducible calcium influx. Positive controls were also prepared with 100 nM (flg22 and Pep1) in MiliQ water, as well as blanks with 0.5% (v/v) DMSO in MiliQ water or MiliQ water. Luminescence was detected and measured for 25-45 min using a Tecan Spark microplate reader (seedlings). The plate was scanned each minute, using 250-ms integration time per well, at a 24° C. constant temperature. All experiments were executed in conditions that ensure minimal disturbance and no physical damage in the leaf disks/seeds (compounds/mixtures were pipetted to avoid any abrasion of the plant issue)

### MAPK Activation

For MAPK activation assays 14-day-old seedlings were used. The growth media was removed by inverting the plate on clean paper towels. Seedlings were treated for 10 min with 1 ml of 3 mg mL-1 of COM, 100 nM flg22 (positive control) or the corresponding mock solutions (solvent control). The COM concentration was chosen due to its ability to cause a string reproducible effect. Two seedlings per treatment were dried on clean paper towels, subsequently transferred to 1.5-mL tubes and instantly frozen in liquid nitrogen. All treated seedlings were stored at −80° C. until further use. Frozen seedlings were pulverized using a nitrogen-cooled plastic micropestle, then mixed with 150 μL of extraction buffer containing 50 mM Tris-HCl PH 7.5, 150 mM NaCl, 2 mM EDTA, 10% (v/v) glycerol, 2 mM DTT, 1% (v/V) Igepal, and supplemented with protease and phosphatase inhibitors (equivalent to Sigma-Aldrich plant protease inhibitor cocktail and phosphatase inhibitor cocktails #2 and #3) was added. The tissue was then ground at 1800 rpm using an automatic stirrer fitted with a plastic micropestle. The tubes were centrifuged at 15,000 g for 20 min at 4° C. in a refrigerated microcentrifuge. After centrifugation, 50 μL of extract were transferred to a fresh 1.5-mL eppendorf tube. Samples were prepared for SDS-PAGE by heating at 80° C. for 10 min in the presence of 6×SDS loading buffer and 100 mM DTT.

Proteins were loaded to a 12% (v/v) polyacrylamide gels, separated at 120 V for≃120 min and subsequently transferred to a PVDF membrane at 100 V for 90 min at 4° C. Membranes were then blocked for 2 h at room temperature or overnight at 4° C. in 5% (w/v) milk in Tris buffered saline (50 mM Tris-HCl pH 7.4, 150 mM NaCl; TBS) containing 0.1% (v/v) Tween-20 (TBS-T). Blots were probed in a 1:4000 dilution of the NEB anti-p42/p44-erk primary antibody in 5% BSA in TBS-T for 2 h, followed by washing 4 times for 10 min each in TBS-T. Blots were then probed with a 1:10000 dilution of anti-rabbit secondary antibody in 5% milk in TBS-T for 1 h, followed by washing 3 times for 5 min each in TBS-T. Finally, blots were washed for 5 min in TBS and treated with either standard ECL substrate or SuperSignal West Femto high sensitivity substrate (ThermoFisher Scientific). Blots were imaged using a Bio-Rad ChemiDoc Imaging System (Bio-Rad Laboratories).

### RNA Extraction and Sequencing

For RNA-seq experiments, 14-day-old seedlings were grown as described above. After nine days of growth in liquid MS medium supplemented with 1% sucrose, the medium was removed from the wells and replaced with 600 μL of fresh liquid MS per well. The following day, 400 μl of 3 mg/mL of COM in 0.5% DMSO in MiliQ water or the corresponding mock solution were added to each well. Seedlings were treated for 10 min and then two wells, for a total of four seedlings were collected and instantly frozen in liquid nitrogen. In total, four biological replicates were generated for each treatment (COM and mock) and stored at −80° C. for further processing.

Frozen seedlings were pulverized while frozen using a Spex SamplePrep Geno Grinder 2010 at 1500 rpm for 90 s. Total RNA was extracted at 4° C. from two ground seedlings as previously described (Shi, H. et al., Methods Mol Biol 323, 2006) by addition of 900 μL of TRI reagent (Ambion) and 200 μL of chloroform, recovery of 400 μL from the aqueous phase, precipitation with 500 μL of isopropanol and washing with 70% ethanol. All samples were then solubilized in 30 μL of RNase-free water. Samples were subsequently subjected to DNase treatment using a TURBO DNA-free Kit (Ambion) according to manufacturer's instructions. The reaction mix was incubated at 37° C. for 30 min, after which the inactivation reagent was added and incubated for 5 min at room temperature. After centrifugation the supernatant was transferred to a new tube. Quantification and quality assessment of all RNA samples were evaluated on a TapeStation (Agilent) and RNA sequencing performed by the Beijing Genomics Institute (BGI).

### RNA-Seq Data Processing

For paired-end RNA sequencing (RNA-seq), libraries were generated at BGI according to the DNBSEQ stranded mRNA library system. Eight samples were indexed and sequenced using the DNBseq™ sequencing platform (20 million reads per sample). Generated FastQ files were analyzed with FastQC, and any low-quality reads were trimmed with Trimmomatic (Bolger, A. M. Bioinformatics 30, 2014).

All libraries were aligned to the A. thaliana genome assembly TAIR10 with gene annotations from Ensembl Plants v. 49 using the HISAT2 v. 2.1.0 pipeline (Kim, D. Nature Methods 2015 12:4, 2015) followed by read counts with HTSeq v. 0.13.5 (Anders, S. et al., Bioinformatics 31, 2015). All RNA-seq experiments were carried out with four biological replicates. Differential expression analysis, and quality control principal-component analysis (PCA) and MA plots were generated using the DESeq2 v. 1.30.0 R package (Love, M. I. et al., Genom Biol 2014 15:12, 2014). The genes that showed |log 2|>1-fold changes in expression with an adjusted P value below 0.05 are defined as significantly differentially expressed genes (DEGs) in this analysis. Transcript abundance was defined as transcripts per kilobase million (TPM). Gene Ontology enrichment of the differentially expressed genes was performed with the topGO v. 2.42.0 R package, using the Fisher exact test to attain significantly enriched categories.

### Comparative Analysis of Transcriptome Modification Upon Elicitor Treatment

Differentially expressed gene lists in response to seven elicitors (3-OH-FA, CO8, elf18, flg22, nlp20, OGs, Pep1) upon treatment under similar conditions as COM were obtained from Bjornson, et al. (2021) ibid. This study followed a time course from 5 min to 3 h post-elicitation: a gene list was obtained for each elicitor with genes significantly induced at any time. Abiotic stress treatment analysis for seven abiotic stresses (heat, cold, drought, salt, high osmolarity, UV-B light, wounding) was also obtained from

Bjornson, et al. (2021), based on ATH1 microarray experiments presented in Killian, et al., The Plant Journal 50, 2007. This study followed a time course from 5 min to 12 h post-elicitation: a gene list was obtained for each elicitor with genes significantly induced at any time up to 3 h. Comparisons and visualizations among differentially expressed genes were performed in R using the tools of the tidyverse v. 1.3.1 package (Wickham, H. et al. J Open Source Softw 4, 2019). Spearman correlation among log 2 (fold changes) for treatments was calculated using the Hmisc package in R v. 4.5-0) and visualized using the corrplot package v. 0.89. Annotation data for genes induced specifically by COM was obtained from the Arabidopsis information resource (TAIR) via Bioconductor package org.At.tair.db v. 3.10.0.

### Quantitative Analyses of Total Carbohydrate Content

To evaluate the sugar moiety content of cutin purified using ionic liquids and oligomeric mixtures derived from its controlled depolymerization, all samples were subjected to an acid hydrolysis (1 M H2SO4 in methanol) for 4 h at 90° C. The hydrolysable sugars were recovered in the supernatant through centrifugation (18514 g, 4° C., 20 minutes) and the pH was neutralized using 5 M NaOH in water. All samples were dried under a flux of nitrogen at room temperature. Quantification of carbohydrates in the dried hydrolysates was performed using the total carbohydrate assay kit from Sigma-Aldrich according to the manufacturer's instructions. The samples were analysed in triplicates.

### NMR Characterization of Cutin Oligomeric Mixtures

NMR spectra of COMs were recorded using an Avance III 800 CRYO (Bruker Biospin, Rheinstetten, Germany). All NMR spectra (¹H, ¹H-¹H COSY, ¹H-¹³C HSQC, ¹H-¹³C HMBC) were acquired in DMSO-d6 using 5 mm-diameter NMR tubes, at 60° C. as follows: 15 mg of COMs in 400 μL of DMSO-d6 (in triplicate) or for validation 40 mg of COMs in 400 μL of DMSO-d6. For quantification purposes, 1.25 mg of benzene (internal standard) was added to each sample. MestReNova, Version 11.04-18998 (Mestrelab Research, S.L.) was used to process the raw data acquired in the Bruker spectrometers.

### GC-MS Characterization of Cutin Oligomeric Mixtures

To release the hydrolysable constituents, the COMs were treated with a solution of 0.5 M NaOH in methanol:water (1:1 [v/v]) at 95° C. for 4 h. The mixture was cooled to room temperature and acidified to pH 3-3.5 with HCl 1 M, spiked with a known concentration of hexadecane (internal standard), and extracted three times with dichloromethane. Sodium sulphate anhydrous was added to the organic phase to remove water and concentrated under a nitrogen flow. The non-hydrolysable fraction was recovered by filtration (cellulose nitrate filter) and subsequently washed, dried, and weighted (recalcitrance). The COMs samples were also analysed directly, i.e. not subjected to alkaline hydrolysis. The dried samples were derivatized in N,O-bis(trimethylsilyl)trifluoroacetamide containing 1% (v/v) of trimethylchlorosilane in pyridine (5:1), for 30 min at 90° C. The derivatives were then analysed by GC-MS (Agilent: 7820A GC and 5977B quadrupole MS; HP-5 MS column) as follows: ramp temperature 80° C., then 2° C.·min-1 to 310° C. for 15 min. The MS scan mode, with source at 230° C. and electron impact ionization (EI+, 70 eV) was used for all samples. Data acquisition was accomplished by MSD ChemStation (Agilent Technologies); compounds were identified based on the equipment spectral library (Wiley-National Institute of Standards and Technology) and quantified using external standards of the major classes of the aliphatic monomers (heptadecanoic acid, hexadecanedioic acid and pentadecanol). All samples were analysed in triplicates, each with technical duplicates.

### LC-MS/MS Characterisation of COMs

The LC-MS/MS protocol was adapted from Bhunia R. et al., Plant Methods 14, (2018). The experiments were performed in a Q Exactive Focus™ Hybrid Quadrupole-Orbitrap™ Mass Spectrometer coupled to a Dionex Ultimate 3000 UHPLC. HPA was used as a standard and prepared in isopropanol: methanol:acetonitrile (1:1:1) at a concentration of 200 ng/μL. The samples were prepared in the same way at 1 μg/μL. Separation was achieved in a Waters XBridge column C18 (2.1×150 mm, 3.5 μm particle size, P/N 186003023), using a gradient of increasing percentage of 20 mM ammonium formate in isopropanol (IPA): acetonitrile (ACN) (75:25) (B) and decreasing percentage of ACN:water (60:40) with 20 mM ammonium formate (A). The total method time was 77 min, the flow rate was 0.4 mL·min-1, and the column was kept at 37° C. The data was acquired using the Xcalibur software v. 4.0.27.19 (Thermo Scientific). The method consisted of several cycles of Full MS scans (R=70000; Scan range=100-1500 m/z) followed by 3 ddMS2 scans (R=17500; NCE 30 V) in positive and negative mode. External calibration was performed using LTQ ESI Positive/Negative Ion Calibration Solution (Thermo Scientific). Generated mass spectra were processed using Compound Discoverer 3.2 (Thermo) for small molecule identification. The search was performed against the mass list with provided molecular formulas (dimers, trimers), as well as mzCloud MS2 database, KEGG and ChEBI MS1 databases. A 3-ppm mass tolerance was used. The minimum peak intensity (MS1) for detection was 10\hat{ }6. A manual validation of the assignments for the identified oligomers was performed by inspection the MS2 fragmentation profiles against the theoretical fragmentation generated on Mass Frontier 8.0 (Thermo). Theoretical chemical structures for the identified oligomers were generated ChemDraw 21.0.0.

### CITED REFERENCES

Zhu, H., Jia, Z., Trush, M. A. & Li, Y. R. A Highly Sensitive Chemiluminometric Assay for Real-Time Detection of Biological Hydrogen Peroxide Formation. React Oxyg Species (Apex) 1, 216 (2016).
Moreira, C. J. S. et al. An ionic liquid extraction that preserves the molecular structure of cutin shown by nuclear magnetic resonance. Plant Physiol 184, (2020).
Willmann, R., Haischer, D. J. & Gust, A. A. Analysis of MAPK Activities Using MAPK-Specific Antibodies. Methods in Molecular Biology 1171, 27-37 (2014).
Bjornson, M., Pimprikar, P., Nürnberger, T. & Zipfel, C. The transcriptional landscape of Arabidopsis thaliana pattern-triggered immunity. Nat Plants 7, 579 (2021).
Shi, H. & Bressan, R. RNA Extraction. Methods Mol Biol 323, 345-348 (2006).
Kim, D., Langmead, B. & Salzberg, S. L. HISAT: a fast spliced aligner with low memory requirements. Nature Methods 2015 12:4 12, 357-360 (2015).
Anders, S., Pyl, P. T. & Huber, W. HTSeq—a Python framework to work with high-throughput sequencing data. Bioinformatics 31, 166-169 (2015).
Love, M. I., Huber, W. & Anders, S. Moderated estimation of fold change and dispersion for RNA-seq data with DESeq2. Genome Biology 2014 15:12 15, 1-21 (2014).
Kilian, J. et al. The AtGenExpress global stress expression data set: protocols, evaluation and model data analysis of UV-B light, drought and cold stress responses. The Plant Journal 50, 347-363 (2007).
Wickham, H. et al. Welcome to the Tidyverse. J Open Source Softw 4, 1686 (2019).
Bhunia, R. K., Showman, L. J., Jose, A. & Nikolau, B. J. Combined use of cutinase and high-resolution mass-spectrometry to query the molecular architecture of cutin. Plant Methods 14, 1-17 (2018).

All scientific publications and patent documents cited in the present specification are incorporated by reference herein.

### SEQUENCES

In the event of discrepancies between the sequences shown in the present specification and those of the enclosed sequence protocol according to WIPO standard ST.26, the sequences shown herein shall prevail.

TABLE 1

| | COM NH | COM AH |
|---|---|---|
| Compound (X) | m (X)/m COM (g) | m (X)/m COM (g) |
| Alkanoic acids | 244.36 ± 7.17 | 203.23 ± 11.79 |
| hexadecanoic acid methyl ester | 26.85 ± 0.71 | n.d. |
| 9,12-octadecadienoic acid methyl ester | 41.08 ± 0.92 | n.d. |
| 9-octadecenoic acid methyl ester | 33.92 ± 0.67 | n.d. |
| octadecanoic acid methyl ester | 25.35 ± 0.74 | n.d. |
| hexadecanoic acid tms | 26.48 ± 0.91 | 37.73 ± 1.80 |
| 9,12-octadecadienoic acid tms | 40.02 ± 1.60 | 86.01 ± 4.96 |
| 9-octadecenoic acid tms | 27.77 ± 1.09 | 53.09 ± 3.60 |
| octadecanoic acid tms | 22.88 ± 0.84 | 26.40 ± 2.04 |
| ω-Hydroxyalkanoic acids | 111.15 ± 3.99 | 182.86 ± 10.33 |
| 16-hydroxyhexadecanoic acid methyl ester | | |
| 10,16-Dihydroxyhexadecanoic acid methyl ester | 37.42 ± 1.39 | 16.43 ± 2.78 |
| 9,10-epoxy-18-hydroxyoctadecanoic acid methyl ester | | |
| 16-hydroxyhexadecanoic acid tms | 27 71 ± 0.72 | 18.16 ± 1.39 |
| 10,16-Dihydroxyhexadecanoic acid tms | 52.02 ± 2.14 | 140.32 ± 8.53 |
| 9,10-epoxy-18-hydroxyoctadecanoic acid tms | | 23.86 ± 0.52 |
| α,ω-Alkanedioic acids | 10.66 ± 0.63 | 51.85 ± 1.97 |
| Nonanedioic acid methyl ester | | |
| Hexadecanedioic acid methyl ester | | |
| Nonanedioic acid tms | 10.66 ± 0.63 | 39.49 ± 0.90 |
| Hexadecanedioic acid tms | n.d. | 12.36 ± 1.33 |
| Aromatics | 15.02 ± 2.87 | 13.00 ± 0.59 |
| 4-hydroxybenzaldehyde methyl ester | | |
| 4-coumaric acid methyl ester | 5.19 ± 0.13 | n.d. |
| 4-hydroxybenzaldehyde tms | 4.31 ± 0.20 | 3.77 ± 0.44 |
| 4-coumaric acid tms | 5.87 ± 0.17 | 9.23 ± 0.19 |

Table 1 shows GC-MS characterization of COM before (NH) and after alkaline hydrolysis (AH). List of the monomeric hydrolysable constituents of each sample after derivatization. Monomers 5 that were not detected in a specific sample are labelled as n.d. tms: Samples were derivatized in N,O-bis(trimethylsilyl)trifluoroacetamide containing 1% (v/v) of trimethylchlorosilane in pyridine (5:1), for 30 min at 90° C. some compounds are represented by their tms-derivative.

TABLE 2

| | Chemical | |
|---|---|---|
| Oligomer | Formula | Mass (Da) |
| DP2: 10,16-dihydroxyhexadecanoic acid (2x) | C₃₂H₆₂O₇ | 558.444839 |
| DP2-me: 10,16-dihydroxyhexadecanoic acid | C₃₃H₆₄O₇ | 572.4604891 |
| (2x) + Me | | |
| DP3: 10,16-dihydroxyhexadecanoic acid (3x) | C₄₈H₉₂O₁₀ | 828.6596185 |
| DP3-me: 10,16-dihydroxyhexadecanoic acid | C₄₉H₉₄O₁₀ | 842.6752686 |
| (3x) + Me | | |

Table 2 shows list of putative oligomeric targets for LC-MS/MS analysis, their chemical formulas and the corresponding exact mass (neutral species only).

TABLE 3

| | PAE | SAE | ME | EE | ArE | Total Esters |
|---|---|---|---|---|---|---|
| COM | 11.16 ± 2.10 | 3.35 ± 0.33 | 68.02 ± 4.04 | 15.85 ± 3.03 | 1.62 ± 0.20 | 16.16 ± 2.73 |
| COM II | 24.36 ± 2.56 | 13.62 ± 1.51 | 40.79 ± 1.62 | 21.23 ± 1.08 | n.d. | 6.35 ± 1.83 |

Table 3 shows NMR quantification of the relative abundances of esters types present in each COM calculated through the integration of signals in the corresponding 1H NMR spectra. Ester types detected on this analysis include, PAE (Primary aliphatic esters), SAE (Secondary aliphatic esters), ME (Methyl esters), EE (Ethyl esters) and ArE (Aromatic Esters). Esters that were not detected on a sample are labelled as n.d.

TABLE 4

| | pg (carbohydrate)/mg (COM) | Carbohydrate content (%) |
|---|---|---|
| COM | 41.05 ± 7.25 | 4.11 × 10⁻⁷ ± 7.25 × 10⁻⁸ |
| COM II | 43.83 ± 25.05 | 4.38 × 10⁻⁷ ± 2.51 × 10⁻⁷ |

Table 4 shows the quantification of the total hydrolysable carbohydrates content present in cutin oligomeric mixtures (COMs).

1. A composition comprising isolated cutin polymer and/or cutin oligomers for use in prevention or treatment of plant disease.

2. A method for prevention or treatment of plant disease, comprising contacting the aerial parts of a plant, particularly leaves and fruit of a plant, with a composition comprising a cutin product consisting of
a. isolated cutin polymer and/or
b. an oligomeric hydrolyzation product of a cutin polymer.

3. The method according to claim 2, wherein the composition is an aqueous composition comprising 0.001% to 0.5% of cutin product, particularly comprising 0.01% to 0.2% (w/w) of cutin product.

4. The method according to claim 2, wherein the cutin product was isolated from tomato pomace.

5. The method according to claim 2, wherein the cutin product is a cutin oligomeric composition obtained by hydrolysis of cutin polymer by sodium methanoate.

6. The method according to claim 2, wherein the cutin product comprises dimers and/or trimers of 10,16-dihydroxyhexadecanoic acid.

7. The method according to claim 6, wherein the dimers and/or trimers of 10,16-dihydroxyhexadecanoic acid are present as methyl ester.

8. The method according to claim 6, wherein the dimers and/or trimers of 10,16-dihydroxyhexadecanoic acid comprise linear dimers or trimers.

9. The method according to claim 6, wherein the composition comprises branched trimers

10. The method according to claim 2, wherein the plant disease is a fungal infection.

11. The method according to claim 2, wherein the plant disease is a bacterial infection.

12. The method according to claim 2, wherein the composition is applied prior to infection.
